(19) United States
(12) Patent Application Publication
(10) Pub. No.: US 2019/0046894 A1
(43) Pub. Date: Feb. 14, 2019

(54) CHORDAL WALL SUPPORT SYSTEM FOR CROSS FLOW TRAYS IN A MASS TRANSFER COLUMN AND METHOD INVOLVING SAME

(71) Applicant: KOCH-GLITSCH, LP, Wichita, KS (US)

(72) Inventors: Darran Headley, Wichita, KS (US); David R. Ewy, Wichita, KS (US)

(73) Assignee: KOCH-GLITSCH, LP, Wichita, KS (US)

(21) Appl. No.: 16/077,519

(22) PCT Filed: Feb. 17, 2017
(86) PCT No.: PCT/US17/18304

§ 371 Date: Aug. 13, 2018

Related U.S. Application Data
(60) Provisional application No. 62/296,979, filed on Feb. 18, 2016.

(51) Int. Cl. B01D 3/32; B01D 3/22

(52) U.S. Cl. CPC B01D 3/326; B01D 3/225

(57) ABSTRACT

A support system is provided to support cross flow trays in vertically spaced-apart relationship within a mass transfer column. The support system includes a chordal wall that has vertically-extending opposite ends that are secured to an external shell of the mass transfer column. Each cross flow tray has a tray deck with fluid flow apertures and at least one chordal downcomer. The chordal downcomers are positioned in vertical alignment on each of the cross flow trays and include downcomer passageways formed by spaced-apart downcomer walls. The chordal wall extends vertically through the downcomer passageways on the cross flow trays and the downcomer walls are coupled with the chordal wall to transfer a load from the tray decks and the downcomer walls to the chordal wall.

### CROSS-REFERENCE TO RELATED APPLICATIONS

This is a 371 application of PCT/US17/18304 filed Feb. 17, 2017, which claims the benefit of prior-filed U.S. provisional Application No. 62/296,979, entitled “CHORDAL WALL SUPPORT SYSTEM FOR CROSS FLOW TRAYS IN A MASS TRANSFER COLUMN AND METHOD INVOLVING SAME,” filed Feb. 18, 2016, the disclosure of which is incorporated herein by reference in its entirety.

### BACKGROUND OF THE INVENTION

The present invention relates generally to cross flow trays used in mass transfer columns in which mass transfer and/or heat exchange processes occur and, more particularly, to apparatus and methods for supporting such cross flow trays.

Cross flow trays are used within mass transfer columns to facilitate interaction between fluid streams flowing in countercurrent relationship within the column. The term mass transfer column as used herein is not intended to be limited to columns in which mass transfer is the primary objective of the processing of the fluid streams within the column, but is also intended to encompass columns in which heat transfer rather than mass transfer is the primary objective of the processing. The fluid streams are typically an ascending vapor stream and a descending liquid stream, in which case the cross flow trays are commonly referred to as vapor-liquid cross flow trays. In some applications, both fluid streams are liquid streams and the cross flow trays are commonly referred to as liquid-liquid cross flow trays. In still other applications, the ascending fluid stream is a gas stream and the descending fluid steam is a liquid stream, in which case the cross flow trays are referred to as gas-liquid cross flow trays.

The cross flow trays are positioned within the column in vertically spaced-apart relationship with each of the tray decks extending horizontally to fill the internal cross-section of the column. Each of the cross flow trays has a planar tray deck on and above which interaction between the ascending fluid stream and the descending fluid stream occurs, a plurality of apertures to allow upward passage of the ascending fluid stream through the tray deck and into the descending fluid stream to create a froth or mixture in which the desired mass transfer and/or heat exchange occurs, and at least one downcomer that directs the descending fluid stream from the associated tray deck to a tray deck on an underlying cross flow tray. The portion of the tray deck that receives the descending fluid stream from the downcomer of an overlying cross flow tray typically comprises an inlet panel that is either imperforate or contains bubble promoters or other structures that allow upward passage of the ascending fluid stream but impede the descending fluid stream from weeping through the inlet panel.

Cross flow trays having a single side downcomer located at one end of the tray deck are known as single-pass trays. In other applications, typically those involving higher descending liquid flow rates, multiple downcomers may be used on some or all of the cross flow trays. For example, in two-pass configurations, two side downcomers are positioned at opposite ends of one cross flow tray and a single center downcomer is positioned in the center of the adjacent cross flow trays. In four-pass configurations, one cross flow tray has two side downcomers and a center downcomer and the adjacent contact trays have two off-center downcomers.

The tray decks of cross flow trays are typically secured by clamps to support rings welded to the interior surface of the column shell. The downcomer walls are also normally bolted at their opposite ends to bolting bars that are welded to the interior surface of the column shell. In some applications, such as in larger diameter columns and in columns in which vibratory forces are a concern, it is known to add further support to portions of the tray deck by using a strut that extends upwardly from major beams, lattice trusses or a system of hangers to connect the tray deck of a cross-flow tray to the downcomer walls of a similar tray located directly above, or below. When hangers are utilized, the downcomer walls act as beams to carry a portion of the load of the coupled tray, thereby reducing sagging and bracing against uplift of the tray deck. These hangers and other structures, however, add complexity to the design and increase the cost of fabrication and installation of the cross flow tray.

In other applications, the inlet panel on the tray deck is formed as a structural beam to provide added support to the tray deck. The inlet panel must then be interconnected to the adjacent portions of the tray deck using fasteners of various types, thereby adding to the complexity in the design and the installation of the tray deck. A need has thus arisen for a method of supporting and bracing the tray deck while reducing the disadvantages resulting from the conventional methods of providing additional support in larger diameter columns and in columns in which vibratory forces are present.

### SUMMARY OF THE INVENTION

In one aspect, the present invention is directed to a tray assembly for use in a mass transfer column. The tray assembly comprises a plurality of cross flow trays vertically spaced from each other, with each cross flow tray comprising a planar tray deck having fluid flow apertures distributed across the tray deck and at least alternating ones of the cross flow trays having at least one chordal downcomer descending from the tray deck for removing liquid from said tray deck. At least one of the chordal downcomers on one of the cross flow trays is positioned in vertical alignment with chordal downcomers on other ones of the cross flow trays. Each of the at least one chordal downcomers is positioned at an opening in the associated tray deck and comprises a pair of spaced-apart downcomer walls extending downwardly from the associated tray deck at the opening to form a downcomer passageway for delivering fluid entering the opening to the tray deck of one of the underlying cross flow trays. The tray assembly further includes a support system supporting the cross flow trays and comprising a chordal wall coupled with the cross flow trays and extending vertically through the cross flow trays and within the downcomer passageways of the aligned chordal downcomers.

In another aspect, the present invention is directed to a mass transfer column comprising an outer column shell defining an open internal volume and a tray assembly as described above positioned in the open internal volume of the shell.

In yet another aspect, the present invention is directed to a method of supporting a plurality of cross flow trays within the open internal region of the outer shell of the mass transfer column. The method comprises the steps of assembling a chordal wall within the open internal region by joining together individual panels within the open internal region, securing vertically-extending opposite ends of the chordal wall to an internal surface of the outer shell of the column, supporting pairs of spaced-apart downcomer walls on opposite sides of the chordal wall at preselected vertically-spaced locations along the chordal wall to form a downcomer passageway between each pair of spaced-apart downcomer walls with the chordal wall extending vertically through the downcomer passageways, securing vertically-extending opposite ends of the downcomer walls to the internal surface of the outer shell of the column, and supporting tray decks having fluid flow apertures distributed across the tray deck on the downcomer walls outside of each of the downcomer passageways.

### BRIEF DESCRIPTION OF THE DRAWINGS

FIG. 1 is a side elevation view of a mass transfer column in which mass and/or heat transfer are intended to occur and in which a portion of the column shell is broken away to show cross flow trays having a chordal wall support system of the present invention;

FIG. 2 is an enlarged, fragmentary, top perspective view of the mass transfer column shown in FIG. 1 with portions of the column shell broken away to show the cross flow trays and the chordal wall support system;

FIG. 3 is an enlarged, fragmentary, bottom perspective view of one of the cross flow trays and the chordal wall support system shown in FIG. 2;

FIG. 4 is a fragmentary, bottom perspective view of several of the cross flow trays and the chordal wall support system shown in FIG. 2, taken on a further enlarged scale;

FIG. 5 is a fragmentary, bottom perspective view of a pair of the cross flow trays and the chordal wall support system, similar to the view shown in FIG. 4, but on a further enlarged scale;

FIG. 6 is a fragmentary, side elevation view of the cross flow trays and chordal wall support system shown in FIG. 2, taken on a further enlarged scale;

FIG. 7 is an enlarged, fragmentary, side elevation view showing the chordal wall support system;

FIG. 8 is an enlarged, fragmentary, side elevation view showing the chordal wall support system and the cross flow trays; and

FIG. 9 is a fragmentary, top perspective view of a pair of the cross flow trays and showing another embodiment of the chordal wall support system.

### DETAILED DESCRIPTION

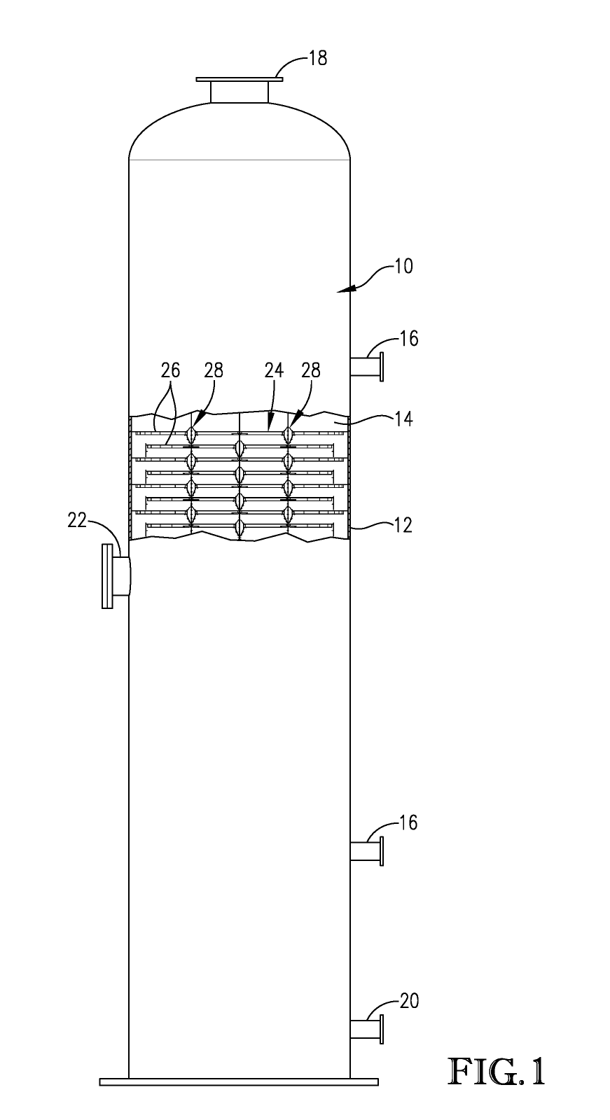

Turning now to the drawings in greater detail and initially to FIG. 1, a mass transfer column suitable for use in processes in which mass transfer and/or heat exchange is intended to occur between countercurrent-flowing fluid streams is represented generally by the numeral 10. Mass transfer column 10 includes an upright, external shell 12 that is generally cylindrical in configuration, although other orientations, such as horizontal, and configurations, including polygonal, are possible and are within the scope of the present invention. Shell 12 is of any suitable diameter and height and is constructed from one or more rigid materials that are desirably inert to, or are otherwise compatible with the fluids and conditions present during operation of the mass transfer column 10.

Mass transfer column 10 is of a type used for processing fluid streams, typically liquid and vapor streams, to obtain fractionation products and/or to otherwise cause mass transfer and/or heat exchange between the fluid streams. For example, mass transfer column 10 can be one in which crude atmospheric, lube vacuum, crude vacuum, fluid or thermal cracking fractionating, coker or visbreaker fractionating, coke scrubbing, reactor off-gas scrubbing, gas quenching, edible oil deodorization, pollution control scrubbing, and other processes occur.

The shell 12 of the mass transfer column 10 defines an open internal region 14 in which the desired mass transfer and/or heat exchange between the fluid streams occurs. Normally, the fluid streams comprise one or more ascending vapor streams and one or more descending liquid streams. Alternatively, the fluid streams may comprise both ascending and descending liquid streams or an ascending gas stream and a descending liquid stream.

The fluid streams are directed to the mass transfer column 10 through any number of feed lines 16 positioned at appropriate locations along the height of the mass transfer column 10. One or more vapor streams may also be generated within the mass transfer column 10 rather than being introduced into the mass transfer column 10 through the feed lines 16. The mass transfer column 10 will also typically include an overhead line 18 for removing a vapor product or byproduct and a bottom stream takeoff line 20 for removing a liquid product or byproduct from the mass transfer column 10. A manway 22 is provided for allowing a person to enter the mass transfer column 10 and for internals to be placed within and removed from the mass transfer column 10 during installation, maintenance, and revamping procedures. Other column components that are typically present, such as reflux stream lines, reboilers, condensers, vapor horns, and the like, are not illustrated in the drawings because they are conventional in nature and an illustration of these components is not believed to be necessary for an understanding of the present invention.

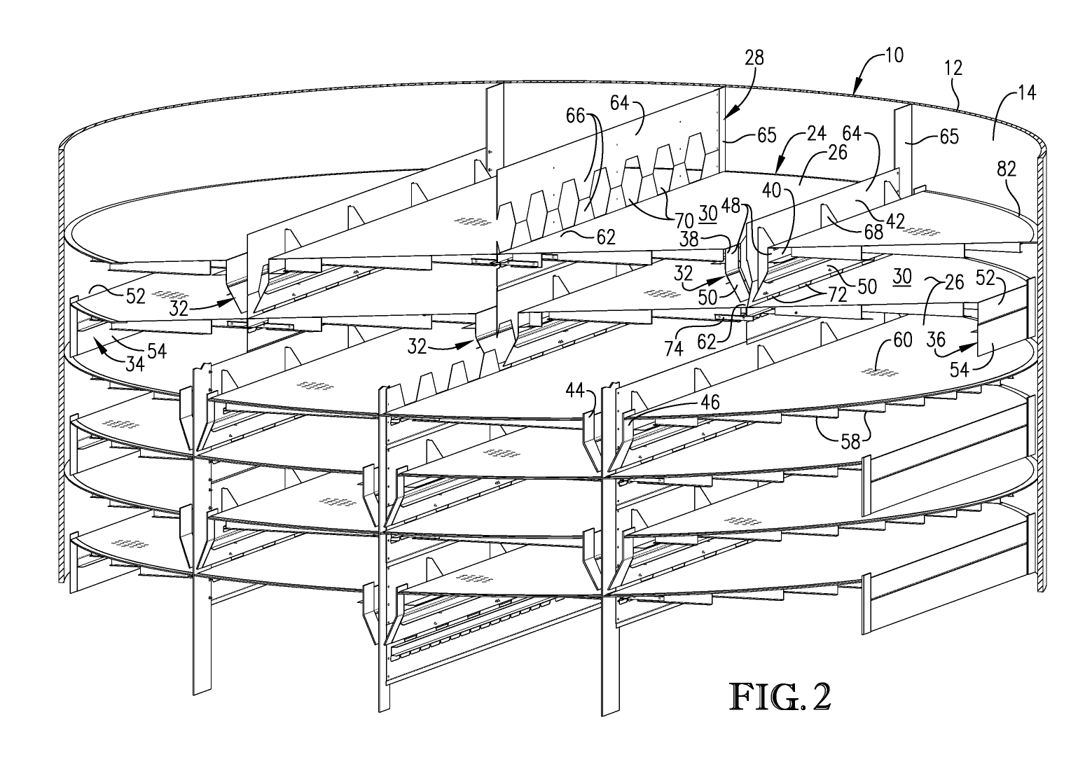

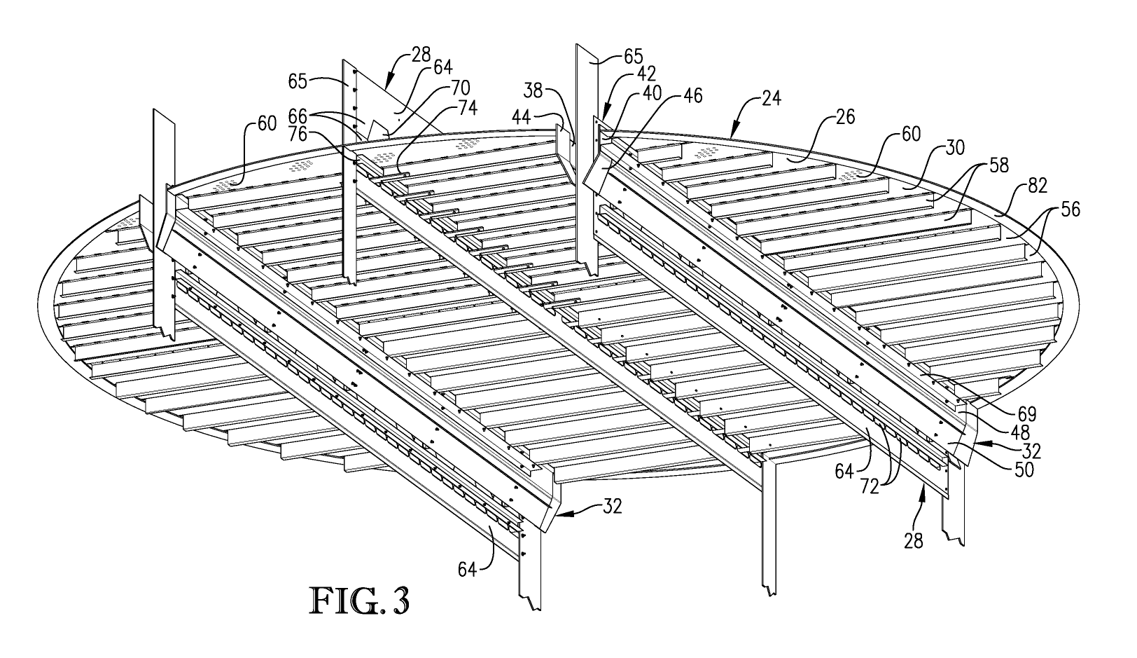

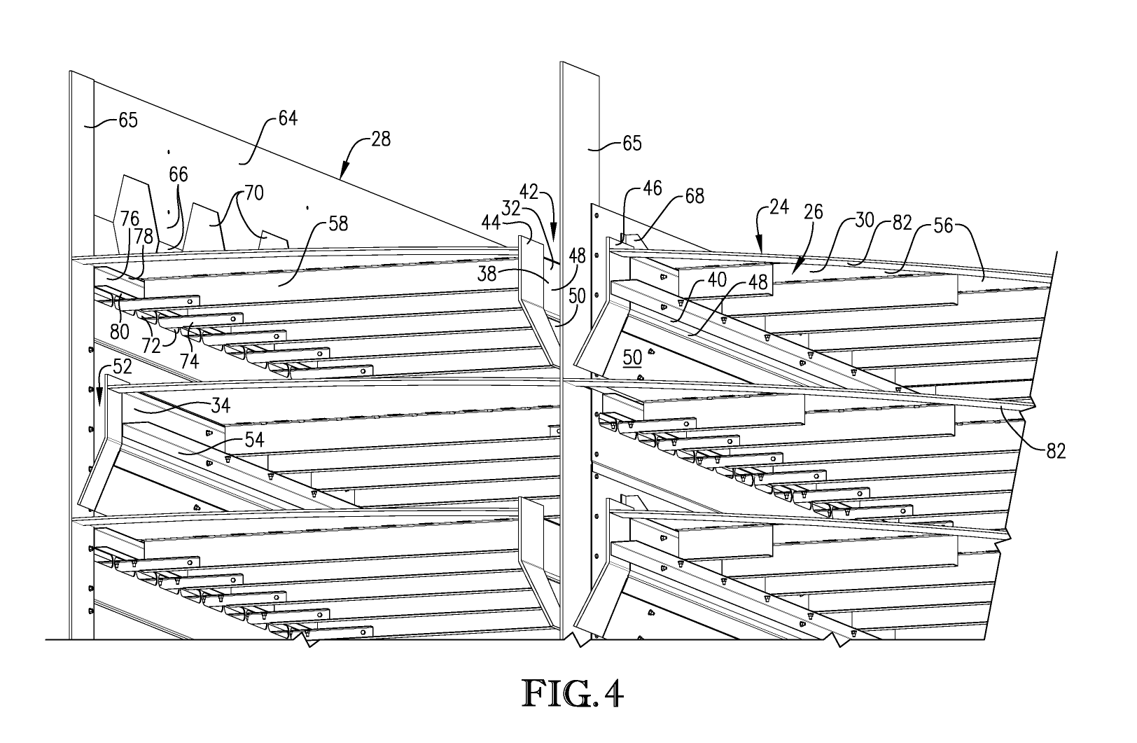

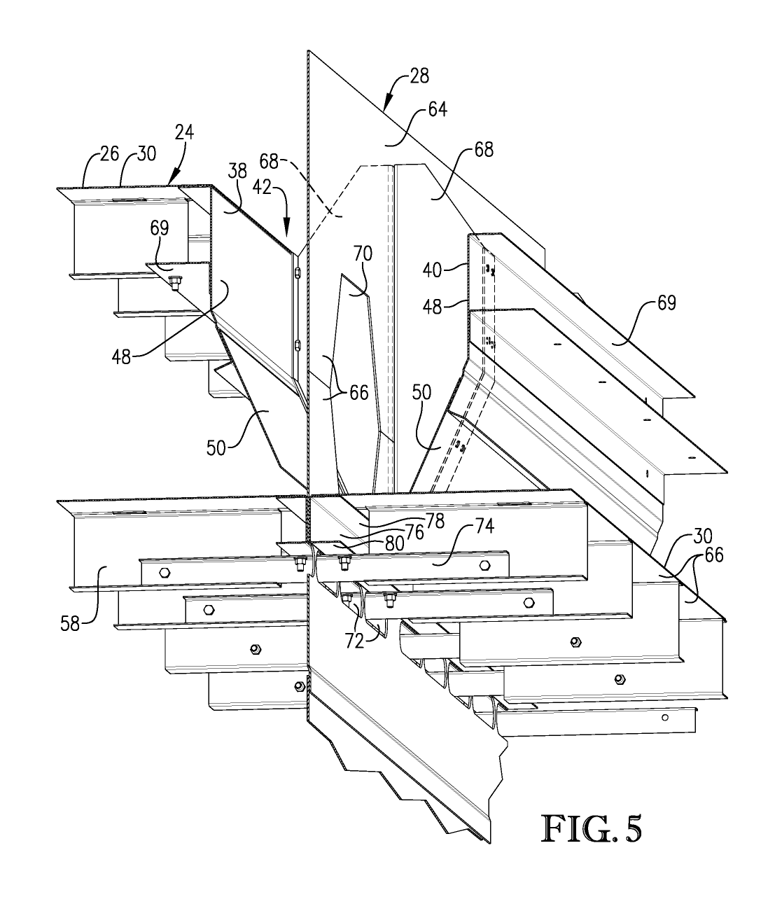

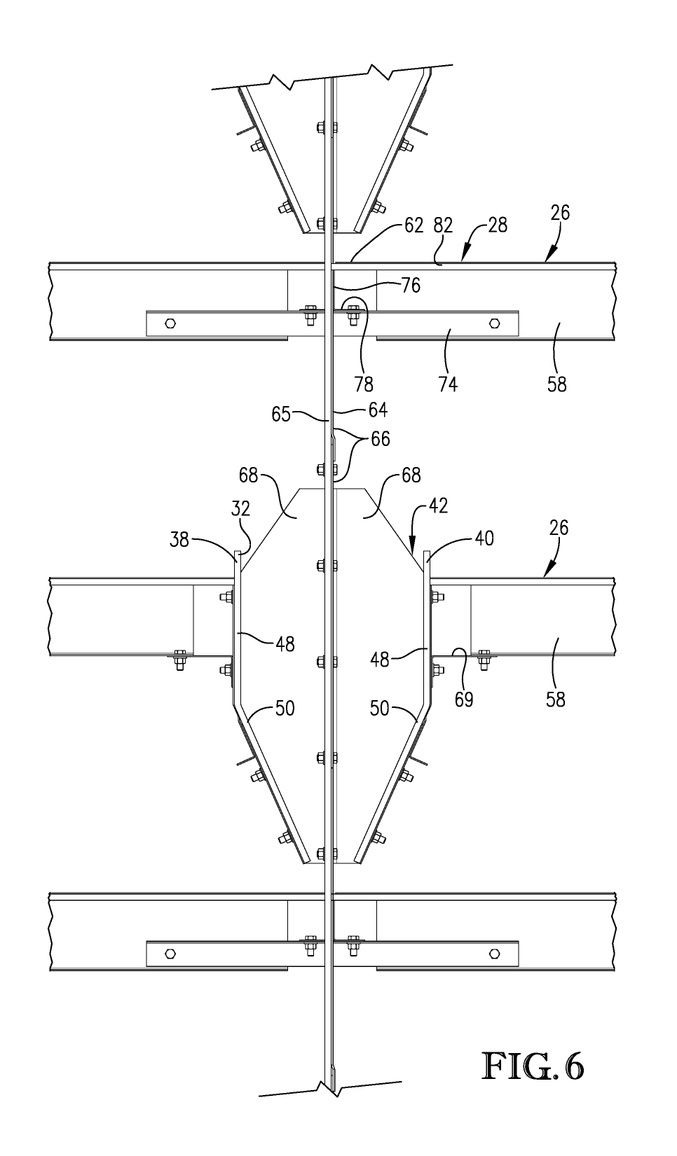

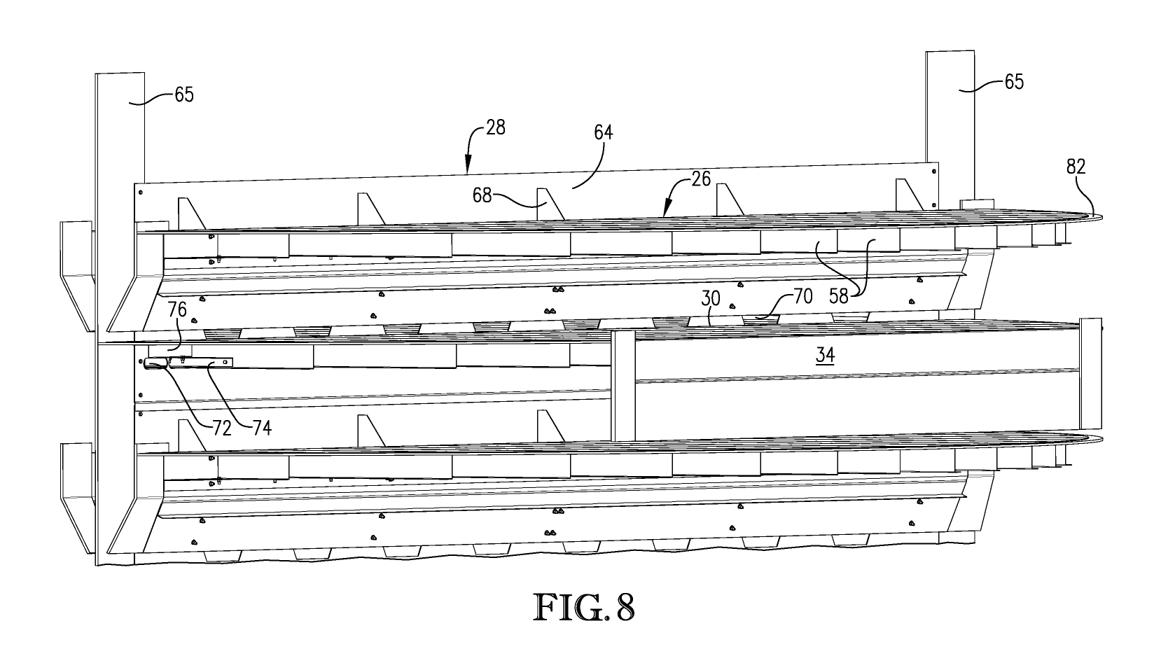

Turning additionally to FIGS. 2-8, a tray assembly 24 is positioned within the open internal region 14 of the mass transfer column 10 and comprises a plurality of horizontally-extending cross flow trays 26 secured and supported in vertically spaced-apart relationship to each other by a support system 28. Each of the cross flow trays 26 comprises a generally planar tray deck 30 and one or more chordal downcomers 32 is positioned at intermediate locations(s) between the ends of the tray deck 30 and/or two side downcomers 34 and 36 are positioned at opposite ends of the tray deck 30. The ends of the tray deck 30 are defined with reference to the general directions of the fluid flow on an upper surface of the tray deck 30. The chordal downcomers 32 and side downcomers 34 and 36 are positioned at openings in the tray deck 30 and descend downwardly for removing liquid from the associated tray deck 30 and delivering it to an underlying tray deck 30, which is normally the immediately underlying tray deck 30.

The chordal downcomers 32 are in vertical alignment on at least some of the cross flow trays 26. The positioning of the chordal downcomers 32 on the cross flow trays 26 is dictated by the desired multiple-pass fluid flow regime on the tray decks 30. In a two-pass flow regime, a single chordal downcomer 32 is normally positioned at the center of the tray deck 30 on alternating ones of the cross flow trays 26 and side downcomers 34 and 36 are used on the other ones of the cross flow trays 26. In the illustrated four-pass flow regime, alternating ones of the cross flow trays 26 have a centrally-located chordal downcomer 32 and side downcomers 34 and 36 and the remaining cross flow trays 26 have two of the chordal downcomers 32 positioned in off-center relationship, normally midway between the center chordal downcomer 32 and the side downcomer 34 or 36 on the adjacent cross flow trays 26. Other multiple-pass flow regimes are within the scope of the present invention as long as the chordal downcomers 32 are in vertical alignment on some of the cross flow trays 26, including in the illustrated embodiment on alternating ones of the cross flow trays 26.

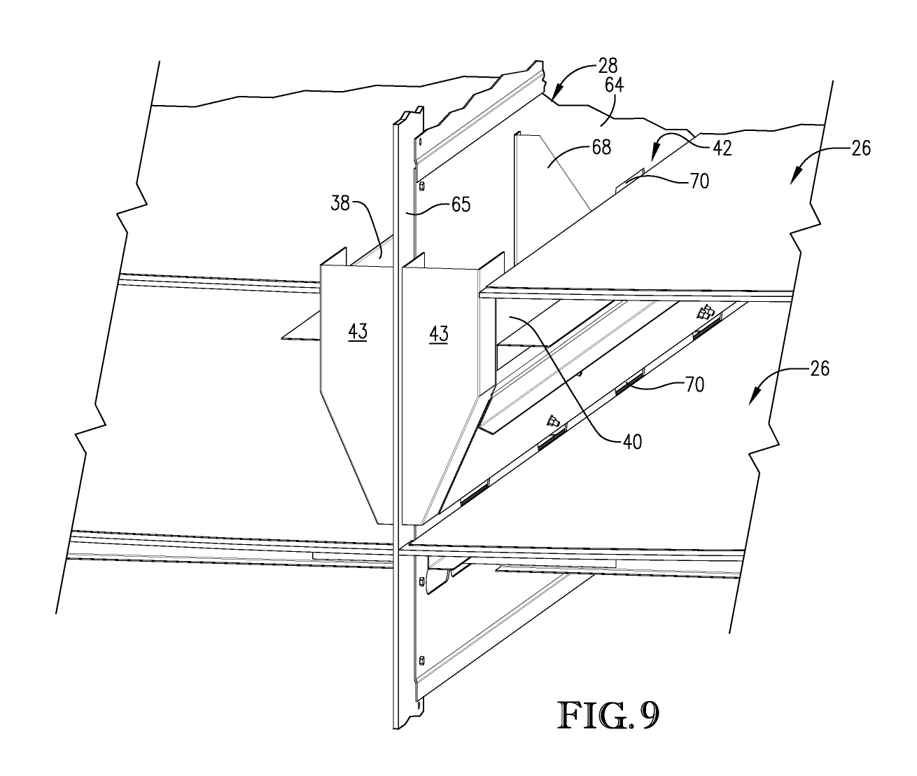

Each chordal downcomer 32 comprises a pair of spaced-apart, parallel downcomer walls 38 and 40 that extend in a chordal fashion across the open internal region 14 within the mass transfer column 10. The spacing between the downcomer walls 38 and 40 forms a downcomer passageway 42 for receiving fluid that enters the associated opening in the tray deck 30 and delivering it to the underlying tray deck 30. Opposite ends of the downcomer walls 38 and 40 are connected to an interior surface of the shell 12, such as by bolting the ends to bolting bars 44 and 46 that are welded to the shell 12. Alternatively, as shown in FIG. 9, the opposite ends of the downcomer walls 38 and 40 may be connected to end brackets 43 that close the opposite ends of the downcomer passageway 42. Each wall 38 and 40 may comprise a vertically-extending upper wall segment 48 and a lower wall segment 50 that is inclined toward the lower wall segment of the opposite wall 38 or 40. The incline lower wall segments 50 constrict the downcomer passageway 42 and cause fluid to fill the constricted portion of the downcomer passageway 42 to impede vapor or a lighter fluid from ascending through the downcomer passageway 42. A lower terminal end of each wall 38 and 40 of the chordal downcomers 32 is positioned a preselected distance above the underlying tray deck 30 to create a clearance area for fluid to be discharged from the downcomer 32 onto a normally imperforate area of the underlying tray deck 30.

The construction of the side downcomers 34 and 36 differs from the chordal downcomers 32 in that a downcomer passageway 52 for fluid is formed by the combination of a single chordal downcomer wall 52 and the shell 12 of the mass transfer column 10, rather than by two chordal downcomer walls.

The tray deck 30 is formed from individual panels 56 that are joined together using any of various conventional methods. The panels 56 extend longitudinally in the direction from one end to the other end of the tray deck 30. Some or all of panels 56 include stiffening flanges 58 that extend perpendicularly downward from the panels 56, typically along one of the longitudinal edges of each of the panels 56. The lines depicting the edges of the panels 56 are not shown in FIG. 2 in order to simplify the illustration.

Most areas of the tray decks 30 include apertures 60 to allow an ascending vapor, gas or liquid stream to pass through the tray deck 30 for interaction with a liquid stream traveling along an upper surface of the tray deck 30. Only some of the apertures 60 are shown in the drawings for ease of illustration. The apertures 60 can be in the form of simple sieve holes or directional louvers or they may include structures such as fixed or movable valves. The portion of the tray deck 30 containing the apertures 60 is known as the active area of the cross flow tray 26.

Portions of the tray deck 26 that underlie the outlets of the chordal downcomers 32 and side downcomers 34 and 36 are normally imperforate and function as inlet regions 62 for receiving liquid flowing downwardly from the overlying chordal downcomer 32 or side downcomer 34 or 36 and redirecting it horizontally across the tray deck 30. The inlet regions 62 may include bubble promoters or other structures to allow the ascending fluid stream to pass upwardly through the inlet regions 62 while impeding or preventing fluid from weeping downwardly through the inlet regions 62.

In accordance with the present invention, the support system 28 comprises one or more planar, chordal walls 64 that are coupled with and extend vertically through the plurality of cross flow trays 26. Each chordal wall 64 has opposite ends that are secured to the column shell, such as by bolting to bolting bars 65 that are welded to the shell 12 of the mass transfer column 10. A lower end of each of the chordal walls 64 may be supported on a grid support, a support ring, and/or other support mechanisms. Each chordal wall 64 is normally formed from individual panels 66 that are sized to fit through the manway 22. The individual panels 66 are then assembled together within the open internal region 14 to form the chordal wall 64 having a desired height. Edges of adjacent panels 66 are interconnected by any of various suitable means such as by bolting, welding, or using connectors of the type disclosed in commonly-assigned U.S. Pat. No. 8,485,504, the disclosure of which is incorporated herein by this reference.

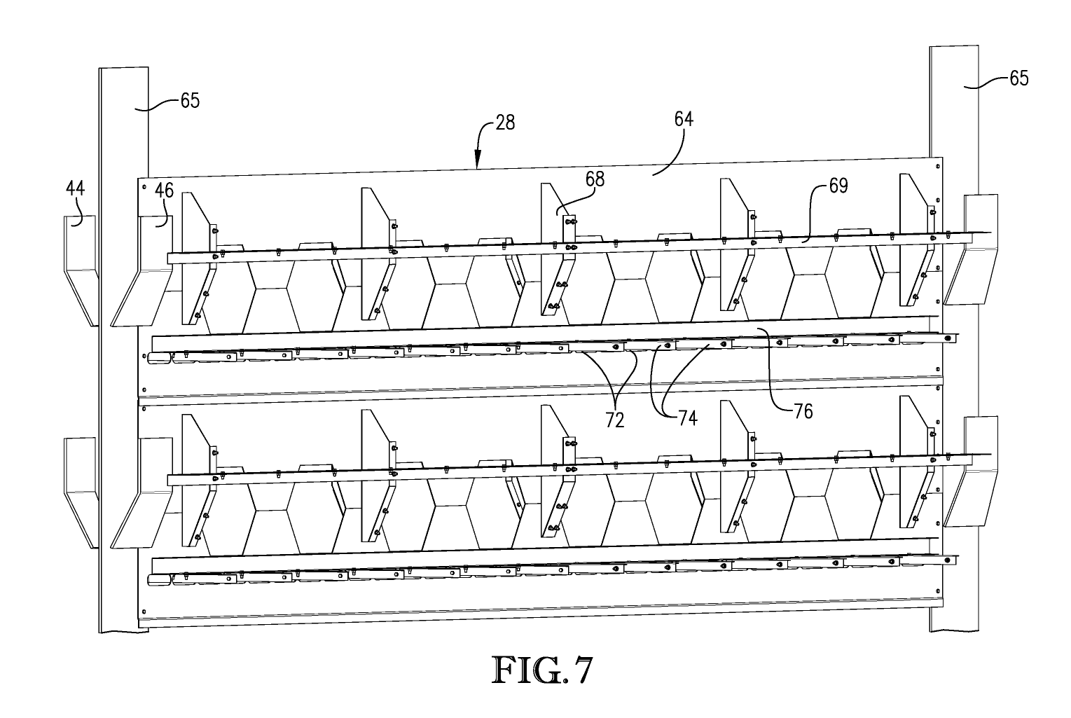

Each chordal wall 64 is positioned so that it passes through the downcomer passageways 42 of one set of vertically-aligned chordal downcomers 32 on some of the cross flow trays 26 and the tray decks 30 of the other cross flow trays 26. The support system 28 includes ear-shaped, downcomer support brackets 68 that are secured on opposite sides of each chordal wall 64 and extend to and are secured to the downcomer wall 38 or 40. The downcomer support brackets 68 on one side of the chordal wall 64 are normally aligned with downcomer support brackets 68 on the opposite side of the chordal wall 64, but they may be offset in other embodiments. A number of the downcomer support brackets 68 are horizontally-spaced along the chordal wall 64 and function to stabilize the chordal downcomers 32 and tray decks 30 and transfer loads from the downcomer walls 38 and 40 and the tray decks 30 onto the chordal walls 64. Angles 69 (FIG. 7) extend horizontally along and are joined to the downcomer walls 38 and 40 and provide surfaces to stabilize the flanges 58.

The downcomer support brackets 68 also serve to subdivide the downcomer passageway 42 into subpassages that may facilitate the desired flow of fluid through the downcomer passageway 42. The portion of each chordal wall 64 located within each downcomer passageway 42 includes a first set of fluid passages 70 that allows fluid that is within the downcomer passageway 42 to pass through the first set of fluid passages 70 from one side of the chordal wall 64 to an opposite side of the chordal wall 64. At least one of the fluid passages 70 is positioned between each adjacent ones of the downcomer support brackets 68 so that fluid within each subpassage is able to pass through the chordal wall 64 for mixing and flow equalization. The fluid passages 70 in one embodiment extend downwardly below the lower terminal end of the adjacent downcomer walls 38 and 40 so that liquid that is discharged onto the inlet region 62 of the tray deck 30 is also able to flow through the chordal wall 64 for mixing and flow equalization purposes. By varying the area of the fluid passages 70 at different regions along the chordal wall, the flow distribution of the fluid on the tray deck 30 may be regulated in a desired manner.

An upper end of the fluid passages 70 is normally positioned below the elevation of the tray deck 30 from which fluid enters the chordal downcomers 32 so that the chordal wall 64 is imperforate in a region above the elevation of the tray deck 30. This imperforate region of the chordal wall 64 then acts as a splash baffle to prevent fluid on the tray deck 30 from jumping across the opening in the tray deck 30 from which the chordal downcomer 32 descends.

The chordal wall 64 includes a second set of fluid passages 72 that are positioned below the inlet region 62 of the tray deck 30 to allow the ascending fluid to pass through the fluid passages 72 from one side of the chordal wall 64 to the opposite side of the chordal wall 64 for pressure and flow equalization.

The support system 28 includes elongated stabilizers 74 that, in one embodiment, pass through the fluid passages 72 from one side of the chordal wall 64 to the opposite side thereof. The elongated stabilizers 74 are secured to the tray deck 30, typically the flanges 58 of the panels 56 of the tray deck 30, on opposite sides of the chordal wall 64 to join and stabilize the segments of the tray deck 30 interrupted by the chordal wall 64.

The support system 28 further includes flanged supports 76 that are secured to opposite sides of the chordal wall 64 and extend horizontally along the chordal wall 64 below and in contact with the inlet region 62 of the tray deck 30. The supports 76 have an upper flange 78 onto which the inlet region 62 of the tray deck 30 is secured and supported and a lower flange 80 that provides a surface onto which the stabilizers 74 may be secured. The supports 76 act to transfer a load from the tray deck 30 onto the chordal wall 64 so that the chordal wall 64 acts to stabilize, support, and maintain the desired position and horizontal alignment of the tray deck 30 even when loaded with fluid. The chordal wall 64 acts to stabilize, support, and maintain the desired position and horizontal alignment of the chordal downcomers 32 and the other tray decks 30 as a result of the downcomer support brackets 68 acting to transfer the loads from those chordal downcomers 32 and tray decks 30 to the chordal wall 64. In this manner, the chordal wall 64 provides an improved alternative to the use of structural beams and other conventional support devices, particularly in larger diameter mass transfer columns 10.

A support ring 82 welded to the shell 12 of the mass transfer column 10 may be used in a conventional fashion to support an outer perimeter of the tray decks 30 on some or all of the cross flow trays 26.

The present invention also encompasses a method of supporting the cross flow trays 26 within the open internal region 14 of the outer shell 12 of the mass transfer column 10. The method includes the steps of assembling the chordal wall 64 within the open internal region 14 by joining together the individual panels 66 within the open internal region 14. The vertically-extending opposite ends of the chordal wall 64 are secured to an internal surface of the outer shell 12, such as by bolting to the bolting bars 65. The pairs of spaced-apart downcomer walls 38 and 40 are secured on opposite sides of the chordal wall 64 at preselected vertically-spaced locations along the chordal wall 64 to form one of the downcomer passageways 42 between each pair of spaced-apart downcomer walls 38 and 40 with the chordal wall 63 extending vertically through the downcomer passageways 42. The vertically-extending opposite ends of the downcomer walls 38 and 40 are secured to the internal surface of the outer shell 12, such as by bolting to bolting bars 44 and 46 or, as shown in FIG. 9, by the use of end brackets 43 that are secured to the bolting bars 65 that support the chordal wall 64. The tray decks 30 are supported on the downcomer walls 38 and 40 outside of each of said downcomer passageways 42, so that the load of the tray decks 30 and chordal downcomers 32 is transferred to the chordal wall 64. Other tray decks 30 are supported on the flanged supports 76 such that their load is also transferred to the chordal wall. A perimeter of the tray decks 30 may be supported on the support ring 82.

From the foregoing, it will be seen that this invention is one well adapted to attain all the ends and objectives hereinabove set forth together with other advantages that are inherent to the structure.

It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A tray assembly for use in a mass transfer column, said tray assembly comprising:
a plurality of cross flow trays vertically spaced from each other, each cross flow tray comprising a planar tray deck having fluid flow apertures distributed across the tray deck and at least alternating ones of the cross flow trays having at least one chordal downcomer descending from the tray deck for removing liquid from said tray deck,
wherein at least one of the chordal downcomers on one of the cross flow trays is positioned in vertical alignment with chordal downcomers on other ones of the cross flow trays,
wherein each of said at least one chordal downcomers is positioned at an opening in the associated tray deck and comprises a pair of spaced-apart downcomer walls extending downwardly from the associated tray deck at said opening to form a downcomer passageway for delivering fluid entering the opening to the tray deck of one of the underlying cross flow trays; and
a support system supporting said cross flow trays and comprising a chordal wall coupled with said cross flow trays and extending vertically through said cross flow trays and within the downcomer passageways of the aligned chordal downcomers.

2. The tray assembly of claim 1, including a first set of fluid passages positioned in said chordal wall within the passageways of said chordal downcomers to allow said fluid that is within said downcomer passageways to pass through the first set of fluid passages from one side of the chordal wall to an opposite side of the chordal wall.

3. The tray assembly of claim 2, wherein said a lower terminal end of each of the downcomer walls is positioned a preselected distance above the tray deck onto which the fluid is delivered to create a clearance area for the fluid to be discharged from the downcomer onto an inlet area of said tray deck.

4. The tray assembly of claim 3, wherein a lower end of the fluid passages in the first set of fluid passages extends below the lower terminal end of the downcomer walls to allow the fluid discharged onto said tray deck to pass through said chordal wall.

5. The tray assembly of claim 4, wherein in each of the chordal downcomers an upper end of the fluid passages in the first set of fluid passages terminates below the tray deck from which the downcomer descends and the chordal wall is imperforate in a region above the tray deck to prevent fluid on the tray deck from jumping across the opening at which the chordal downcomer is positioned.

6. The tray assembly of claim 3, including a second set of fluid passages positioned in said chordal wall below the inlet area of the tray decks to allow fluid to pass through the second set of fluid passages from one side of the chordal wall to an opposite side of the chordal wall.

7. The tray assembly of claim 3, wherein said support system includes elongated stabilizers extending through at least some of the fluid passages in said second set of fluid passages and joined to said tray deck on opposite sides of the chordal wall.

8. The tray assembly of claim 7, wherein said support system includes supports secured to opposite sides of the chordal wall and extending horizontally along said chordal wall below the inlet areas of the tray decks, said supports providing an upper flange onto which the tray deck is secured and a lower flange onto which said stabilizers are secured.

9. The tray assembly of claim 2, wherein said chordal wall is formed from individual panels that are joined together and the chordal downcomers on alternating trays are in vertical alignment.

10. The tray assembly of claim 2, wherein said support system includes downcomer support brackets positioned within said downcomer passageways on opposite sides of said chordal wall, each downcomer support bracket extending from said chordal wall to one of the downcomer walls to transfer a load from the downcomer wall and associated tray deck to the chordal wall.

11. The tray assembly of claim 10, wherein said downcomer support brackets on one side of the chordal wall are aligned with said downcomer support brackets on the other side of said chordal wall.

12. A mass transfer column comprising:
an outer column shell defining an open internal volume; and
a tray assembly positioned within the open internal volume, said tray assembly comprising:
a plurality of cross flow trays vertically spaced from each other, each cross flow tray comprising a planar tray deck extending horizontally across a cross section of the open internal volume and having fluid flow apertures distributed across the tray deck and at least alternating ones of the cross flow trays having at least one chordal downcomer descending from the tray deck for removing liquid from said tray deck,
wherein at least one of the chordal downcomers on the alternating ones of the cross flow trays is positioned in vertical alignment with at least one of the chordal downcomers on the other alternating ones of the cross flow trays,
wherein each of said at least one chordal downcomers is positioned at an opening in the associated tray deck and comprises a pair of spaced-apart downcomer walls extending downwardly from the associated tray deck at said opening to form a downcomer passageway for delivering fluid entering the opening to the tray deck of one of the underlying cross flow trays; and
a support system supporting said cross flow trays and comprising a chordal wall coupled with said cross flow trays and extending vertically through said cross flow trays and within the downcomer passageways of the aligned chordal downcomers, said chordal wall having vertically-extending opposite ends that are secured to the column shell.

13. The mass transfer column of claim 12, including a first set of fluid passages positioned in said chordal wall within the passageways of said chordal downcomers to allow said fluid that is within said downcomer passageways to pass through the first set of fluid passages from one side of the chordal wall to an opposite side of the chordal wall.

14. The mass transfer column of claim 13, wherein said downcomer walls have vertically-extending opposite ends that are secured to the column shell and wherein a lower terminal end of each of the downcomer walls is positioned a preselected distance above the tray deck onto which the fluid is delivered to create a clearance area for the fluid to be discharged from the downcomer onto an inlet area of said tray deck.

15. The mass transfer column of claim 14, wherein a lower end of the fluid passages in the first set of fluid passages extends below the lower terminal end of the downcomer walls to allow the fluid discharged onto said tray deck to pass through said chordal wall.

16. The mass transfer column of claim 15, wherein in each of the chordal downcomers an upper end of the fluid passages in the first set of fluid passages terminates below the tray deck from which the downcomer descends and the chordal wall is imperforate in a region above the tray deck to prevent fluid on the tray deck from jumping across the opening at which the chordal downcomer is positioned.

17. The mass transfer column of claim 14, including a second set of fluid passages positioned in said chordal wall below the inlet areas of the tray decks to allow fluid to pass through the second set of fluid passages from one side of the chordal wall to an opposite side of the chordal wall.

18. The mass transfer column of claim 14, wherein said support system includes elongated stabilizers extending through at least some of the fluid passages in said second set of fluid passages and joined to said tray deck on opposite sides of the chordal wall.

19. The mass transfer column of claim 18, wherein said support system includes supports secured to opposite sides of the chordal wall and extending horizontally along said chordal wall below the inlet areas of the tray decks, said supports providing an upper flange onto which the tray deck is secured and a lower flange onto which said stabilizers are secured.

20. The mass transfer column of claim 13, wherein said support system includes downcomer support brackets positioned within said downcomer passageways on opposite sides of said chordal wall, each downcomer support bracket extending from said chordal wall to one of the downcomer walls to transfer a load from the downcomer wall and associated tray deck to the chordal wall.

21. A method of supporting a plurality of cross flow trays within an open internal region of an outer shell of a mass transfer column, said method comprises the steps of:
assembling a chordal wall within the open internal region by joining together individual panels within the open internal region;
securing vertically-extending opposite ends of the chordal wall to an internal surface of the outer shell of the column;
supporting pairs of spaced-apart downcomer walls on opposite sides of the chordal wall at preselected vertically-spaced locations along the chordal wall to form a downcomer passageway between each pair of spaced-apart downcomer walls with the chordal wall extending vertically through the downcomer passageways;
securing vertically-extending opposite ends of the downcomer walls to the internal surface of the outer shell of the column; and
supporting tray decks on the downcomer walls outside of each of said downcomer passageways, said tray decks having fluid flow apertures distributed across the tray deck.
